(19) United States
(12) Patent Application Publication
(10) Pub. No.: US 2008/0124516 A1
(43) Pub. Date: May 29, 2008

(54) Method for Producing Porous Ceramic Structure

(75) Inventors: Yasushi Noguchi, Aichi-prefecture (JP); Hiroyuki Suenobu, Aichi-prefecture (JP)

Correspondence Address: OLIFF & BERRIDGE, PLC, P.O. BOX 320850, ALEXANDRIA, VA, 22320-4850, US

(73) Assignee: NGK Insulators, Ltd., Nagoya (JP)

(21) Appl. No.: 10/591,991

(22) PCT Filed: Mar. 16, 2005
(86) PCT No.: PCT/JP05/04652

§ 371 Date: Sep. 7, 2006

(30) Foreign Application Priority Data
Mar. 19, 2004 (JP) 2004-081261

(51) Int. Cl. C04B 38/06

(52) U.S. Cl. 428/117; 501/82; 428/313.7; 428/116

(57) ABSTRACT

Disclosed is a method for producing a porous ceramic structure wherein as a pore-forming agent, hollow particles (microcapsules) made of an organic resin are used, and as at least one type of raw material particles, particles are used which contain 30 to 100 mass % of particles (spherical particles) having a circularity of 0.70 to 1.00 with respect to the total mass of the particles.

### TECHNICAL FIELD

The present invention relates to a method for producing a porous ceramic structure preferably for use as, for example, a filtering material of a filter, more particularly to a method for producing a porous ceramic structure in which an inherent pore-forming effect of a pore-forming agent can be exerted to the maximum, and a high-porosity porous ceramic structure can be obtained by addition of a small amount of the pore-forming agent.

### BACKGROUND ART

In various fields including chemistry, electric power, iron and steel and industrial waste disposal, as a filtering material of a filter for use in applications of an environmental measure such as prevention of pollution, recovery of a product from a high-temperature gas and the like, a porous ceramic structure is used which is made of a ceramic having excellent resistances to heat and corrosion. As a dust collecting filter for use in a high-temperature atmosphere of a corrosive gas, such as a diesel particulate filter (DPF) which traps particulate matters (PM) discharged from a diesel engine such as a car diesel engine, a honeycomb-shape porous ceramic structure (hereinafter referred to as “porous honeycomb structure”) is preferably used.

As the porous honeycomb structure for use in the dust collecting filter, in, for example, a dust collecting filter 21 shown in FIG. 1, a porous honeycomb structure 25 is generally used in which a large number of cells 23 are defined and formed by partition walls 24, and further an inlet-side end face B and an outlet-side end face C of the large number of cells 23 are alternately plugged by portions 22. According to the dust collecting filter 21 having such a structure, a gas G₁ to be treated, which has been introduced from the inlet-side end face B into a part of the cells 23, passes through the partition wall 24 to flow into the adjacent cell 23. In this case, the particulate matters included in the gas G₁ to be treated are trapped in the partition wall 24. Moreover, a treated gas G₂, which has passed through the partition wall 24 to flow into the adjacent cell 23, is discharged from the outlet-side end face C. Therefore, it is possible to obtain the treated gas G₂ from which the particulate matters in the gas G₁ to be treated have been separated and removed.

In addition, in recent years, since it is necessary to reduce pressure losses in a case where the gas passes through the partition wall, and improve a treatment capability of the dust collecting filter, there has been a demand for a high-porosity porous ceramic structure. Examples of a method for producing such a high-porosity porous ceramic structure include a method for producing a porous ceramic structure which has already been disclosed by the present applicant and in which in addition to a ceramic material (so-called aggregate particles), a foamed resin (so-called microcapsules), a forming auxiliary and the like are mixed, and formed to obtain a formed body, and the formed body is fired to thereby obtain the porous ceramic structure (see, e.g., Patent Document 1).

According to the above producing method, when the formed body is fired, combustible microcapsules made of an organic resin burn out to form pores, and it is therefore possible to obtain the high-porosity porous ceramic structure. Such a pore-forming effect can be obtained even in a case where combustible powder such as graphite is used as the pore-forming agent, but the microcapsules used as the pore-forming agent in the above producing method are hollow particles. In consequence, the pore-forming effect per unit mass is high, and it is possible to expect an effect that the high-porosity porous ceramic structure can be obtained by addition of a small amount of the microcapsules.

Patent Document 1: Japanese Patent Application Laid-Open No. 2002-326879

### DISCLOSURE OF THE INVENTION

However, the above producing method is an effective method in that a certain pore-forming effect can be obtained, but the porous ceramic structure is not necessarily obtained which has a porosity in accordance with an added amount of microcapsules in the actual situation. Therefore, to obtain a high-porosity porous ceramic structure, a large amount of microcapsules have to be added.

The above addition of the large amount of microcapsules is not preferable in that there might be generated various disadvantages: i) a firing time of a formed body becomes longer than necessary, and energy consumption during the firing increases; ii) an amount of heat to be generated during burning of the microcapsules increases, and therefore cracks are generated in the porous ceramic structure owing to thermal stress; and iii) product cost rises owing to the increased amount of microcapsules and extension of the firing time. That is, from a viewpoint that a high pore-forming effect be obtained by the addition of the small amount of the pore-forming agent, the above producing method is not sufficiently satisfactory yet, and room for improvement is still left.

As described above, at present, any method for producing the porous ceramic structure has not been disclosed yet in which the high-porosity porous ceramic structure can be obtained by the addition of a small amount of the pore-forming agent, and there is an earnest demand for development of such a producing method in the industrial world. The present invention has been developed to solve the above program of the conventional technology, and there is provided a method for producing a porous ceramic structure, which produces an advantageous effect that it is possible to exert an inherent pore-forming effect of the pore-forming agent to the maximum, and it is possible to obtain a high-porosity porous ceramic structure by addition of a small amount of the pore-forming agent, as compared with the conventional method.

As a result of intensive researches to solve the above problem, the present inventors have found that in a case where raw material particles, microcapsules and the like are mixed and kneaded, the microcapsules are damaged and collapsed by aspherical particles existing in the raw material particles, this deteriorates the pore-forming effect of the microcapsules, and this is why it is not possible to obtain the porous ceramic structure having a porosity in accordance with the added amount. Moreover, it has been considered that in addition to the use of the microcapsules as the pore-forming agent, according to an inventive constitution in which spherical particles having a circularity appropriately controlled are used as the raw material particles, the above problem can be solved, and the present invention has been completed. That is, according to the present invention, there is provided the following method for producing the porous ceramic structure.

[1] A method for producing a porous ceramic structure, comprising: a mixing and kneading step of mixing and kneading a clay material containing raw material particles and a pore-forming agent together with a dispersion medium to obtain a clay; a forming and drying step of forming the clay to obtain a formed ceramic body, and drying the formed ceramic body to obtain a dried ceramic body; and a firing step of firing the dried ceramic body to thereby obtain the porous ceramic structure, wherein as the pore-forming agent, hollow particles (microcapsules) made of an organic resin are used, and as at least one type of the raw material particles, particles are used which contain 30 to 100 mass % of particles (spherical particles) having a circularity of 0.70 to 1.00 with respect to the total mass of the raw material particles.

[2] The method for producing the porous ceramic structure according to the above [1], wherein the spherical particles have a circularity of 0.80 to 1.00.

[3] The method for producing the porous ceramic structure according to the above [1] or [2], wherein the clay is formed into a honeycomb shape in which a large number of cells are defined and formed by partition walls.

[4] The method for producing the porous ceramic structure according to any one of the above [1] to [3], wherein the spherical particles are obtained by heating ceramic particles at a temperature in a range of a melting point (Tm) of a ceramic to Tm+300° C.

[5] The method for producing the porous ceramic structure according to any one of the above [1] to [3], wherein the spherical particles are obtained by crushing the ceramic particles with a jet air current.

[6] The method for producing the porous ceramic structure according to any one of the above [1] to [5], wherein as the raw material particles, there are used cordierite (2MgO.2Al₂O₃.5SiO₂) forming material particles composed of silica (SiO₂) particles, kaolin (Al₂O₃.2SiO₂.2H₂O) particles, alumina (Al₂O₃) particles, aluminum hydroxide (Al(OH)₃) particles and talc (3MgO.4SiO₂.H₂O) particles, and as at least one type of the silica (SiO₂) particles, the alumina (Al₂O₃) particles and the aluminum hydroxide (Al(OH)₃) particles, there are used particles which contain 30 to 100 mass % of the spherical particles with respect to the total mass of the particles.

[7] The method for producing the porous ceramic structure according to the above [6], wherein the spherical particles are obtained by heating the silica (SiO₂) particles in flame at a temperature in a range of 1730 to 2030° C.

[8] The method for producing the porous ceramic structure according to the above [6] or [7], wherein the spherical particles are the silica (SiO₂) particles having an average particle diameter of 5 to 50 μm.

[9] The method for producing the porous ceramic structure according to any one of the above [1] to [8], wherein the mixing and kneading step mixes and kneads the mixed material together with the dispersion medium at a reduced pressure of −40000 Pa to −93000 Pa to thereby obtain the clay.

Moreover, according to the present invention, the following porous ceramic structure is provided.

[10] A porous ceramic structure obtained by: forming a clay obtained by mixing and kneading, together with a dispersion medium, a clay material containing silica (SiO₂) particles, kaolin (Al₂O₃.2SiO₂.2H₂O) particles, alumina (Al₂O₃) particles, aluminum hydroxide (Al(OH)₃) particles, talc (3MgO.4SiO₂.H₂O) particles and a pore-forming agent; drying the clay; and firing the clay, the porous ceramic structure being a porous honeycomb structure containing cordierite (2MgO.2Al₂O₃.5SiO₂) as a main constituting component and having a porosity of 60 to 72% and an average pore diameter of 15 to 32 μm, wherein as the pore-forming agent, hollow particles (microcapsules) made of an organic resin are used, and as at least one type of the silica (SiO₂) particles, the alumina (Al₂O₃) particles and the aluminum hydroxide (Al(OH)₃) particles, particles are used which contain 30 to 100 mass % of particles (spherical particles) having a circularity of 0.70 to 1.00 with respect to the total mass of the particles.

[11] The porous ceramic structure according to the above [10], having a honeycomb shape in which a large number of cells are defined and formed by porous partition walls.

[12] The porous ceramic structure according to the above [11], further comprising:

plug portions which alternately plug one opening of the large number of cells and the other opening thereof.

The method for producing the porous ceramic structure of the present invention produces an advantageous effect that it is possible to exert an inherent pore-forming effect of the pore-forming agent to the maximum, and it is possible to obtain a high-porosity porous ceramic structure by addition of a small amount of the pore-forming agent, as compared with a conventional method.

### BRIEF DESCRIPTION OF THE DRAWINGS

FIG. 1 is a schematic diagram showing an example of a dust collecting filter using a porous honeycomb structure.

FIG. 2 is a schematic diagram showing a “honeycomb shape” in accordance with an example of a porous honeycomb structure.

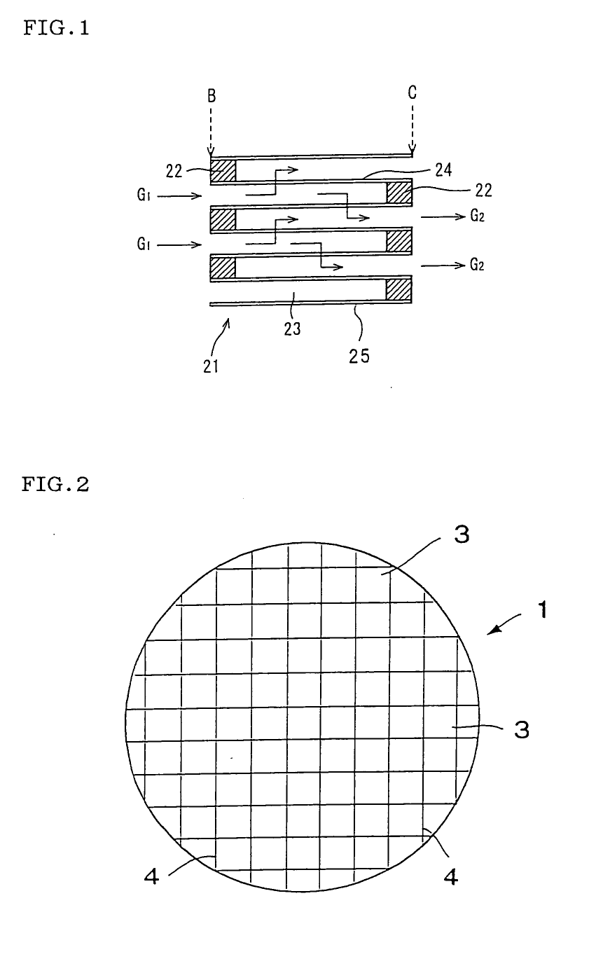

### DESCRIPTION OF REFERENCE NUMERALS

1, 25 . . . porous honeycomb structure, 3, 23 . . . cell, 4, 24 . . . partition wall, 21 . . . dust collecting filter, 22 . . . plug portion, B . . . inlet-side end face, C . . . outlet-side end face, G₁ . . . gas to be treated and G₂ . . . treated gas.

### BEST MODE FOR CARRYING OUT THE INVENTION

There will be described specifically hereinafter the best mode for carrying out the method for producing a porous ceramic structure of the present invention.

It is to be noted that in the present description, “average particle diameter” refers to a value of a 50% particle diameter measured by an X-ray transmission type particle size distribution measurement device (e.g., trade name: Sedigraph 5000-02 model, manufactured by SHIMADZU Corporation) in which the Stokes liquid-phase sedimentation process is used as a measurement principle, and detection is performed by an X-ray transmission process.

Moreover, in the present description, “average pore diameter” refers to a pore diameter measured by mercury porosimetry using the following equation (1) as a principle equation, the pore diameter being calculated from a pressure P in a case where an accumulated capacity mercury forced into a porous material is 50% of the total pore volume of the porous material:

d=−γ×cos θ/P (1),

wherein d: pore diameter, γ: surface tension of interface between liquid and air, θ: contact angle and P: pressure.

Furthermore, in the present description, the “porosity” refers to porosity Pₒ calculated from the total pore volume V of the porous material obtained by the mercury porosimetry and true specific gravity dₜ (2.52 g/cm³) in case of cordierite) of a material constituting the porous material based on the following equation (2):

Pₒ=V/(V+1/dₜ)×100 (2),

wherein Pₒ: porosity, V: total pore volume and dₜ: true specific gravity.

Furthermore, in the present description, “circularity” is an index indicating a degree with which each shape of raw material particles as viewed along the plane deviates from a perfect circle, and refers to circularity SD calculated from projection area S and peripheral length L of the raw material particles measured using a flow type particle image analysis device (e.g., trade name: FPIA-2000, manufactured by Sysmex Corporation or the like) based on the following equation (3). The index of a circularity of 1.00 indicates the perfect circle. The smaller value indicates that there is a large deviation from the perfect circle.

SD=4πS/L² (3),

wherein SD: circularity, S: projection area and L: peripheral length.

A. Method for Producing Porous Ceramic Structure

To develop the method for producing a porous ceramic structure of the present invention, the present inventor has first investigated a reason why in a conventional producing method, a pore-forming effect of microcapsules is not sufficient, and the porous ceramic structure having a porosity adapted to an added amount cannot be obtained. As a result, it has been found that when raw material particles, microcapsules and the like are mixed and kneaded, the microcapsules are damaged and collapsed by aspherical particles existing in the raw material particles.

For example, as silica source particles as a raw material of the cordierite porous ceramic structure, it is general to use easily-obtainable inexpensive crushed silica particles (hereinafter referred to as “crushed silica particles”), but the crushed silica particles have an aspherical shape having many edge portions. Therefore, in a case where the raw material particles, the microcapsules and the like are mixed and kneaded, remarkably thin shell portions of the microcapsules are sometimes damaged and collapsed. In such a case, since the microcapsules cannot maintain an original shape (hollow spherical shape), it is difficult to exert the inherent pore-forming effect of the microcapsules to the maximum. Therefore, to obtain a high-porosity porous ceramic structure, a large amount of microcapsules have to be added.

To solve the problem, in the present invention, in addition to the use of the microcapsules as the pore-forming agent, the spherical particles having a circularity appropriately controlled be used as the raw material particles. To be more specific, as at least one type of raw material particles, there be used particles containing 30 to 100 mass % of particles (spherical particles) having a circularity of 0.70 to 1.00 with respect to the total mass of the particles.

In such a producing method, since a ratio of the aspherical particles in the raw material particles is reduced, in a case where the raw material particles, the microcapsules and the like are mixed and kneaded, a situation is effectively prevented in which the microcapsules are damaged and collapsed by the aspherical particles. Therefore, the inherent pore-forming effect of the pore-forming agent can be exerted to the maximum, and the high-porosity porous ceramic structure can be obtained by addition of a small amount of the pore-forming agent.

To be more specific, there are produced various preferable effects: i) a firing time of a formed body can be shortened, and energy consumption during firing can be reduced; ii) an amount of heat to be generated during burning of the microcapsules is minimized, and it is therefore possible to avoid a situation in which cracks are generated in the porous ceramic structure owing to thermal stress; iii) product cost can be reduced by the reduction of the amount of the microcapsules and the reduction of the firing time; and iv) it is possible to prevent a situation in which the microcapsules are locally collapsed, and therefore a partial fluctuation of the porosity of the porous ceramic structure can be suppressed.

(1) Mixing and Kneading Step:

In the producing method of the present invention, a first step is a mixing and kneading step of mixing and kneading a mixed material containing at least raw material particles and a pore-forming agent together with a dispersion medium to thereby obtain a clay.

(i) Raw Material Particles

Aggregate particles are particles as a main constituting component of the porous ceramic structure (sintered article), and raw material particles are particles as a raw material of the raw material particles. As the raw material particles in the present invention, there can be used particles obtained by using various ceramic or metal particles alone or mixing the particles which have heretofore been used as the constituting component of the porous ceramic structure. To be more specific, it is preferable that there are used particles of a cordierite forming material, mullite, alumina, aluminum titanate, lithium aluminum silicate, silicon carbide, silicon nitride or metal silicon in that a high resistance to heat can be imparted to the resultant porous ceramic structure. Although metal silicon is not a ceramic, for example, it is sometimes used as the aggregate particles of a metal silicon combined silicon carbide (Si—SiC) sintered article.

In the producing method of the present invention, the raw material particles may contain a component other than the above components, but from a viewpoint that the heat resistance is securely imparted to the resultant porous ceramic structure, it is preferable that a ratio of the total mass of the above components with respect to the total mass of the raw material particles is 50 mass % or more (i.e., 50 to 100 mass %).

In the present description, “cordierite forming material particles” mean particles of a substance which can be fired to be converted into cordierite, and are specifically a mixture constituted of silica source particles, alumina source particles and magnesia source particles. There are usually preferably used: these particles mixed so that a composition after fired is a theoretical composition (2MgO.2Al₂O₃.5SiO₂) of cordierite, specifically particles obtained by mixing the silica source particles at a ratio of 47 to 53 mass % in terms of silica, the alumina source particles at a ratio of 32 to 38 mass % in terms of alumina and the magnesia source particles at a ratio of 12 to 16 mass % in terms of magnesia.

The silica source particles may be particles of silica, silica-containing composite oxide, a substance converted into silica when fired or the like. Typical examples of the particles include particles of silica (SiO₂) including quartz, kaolin (Al₂O₃.2SiO₂.2H₂O), talc (3MgO.4SiO₂.H₂O), mullite (3Al₂O₃.2SiO₂) and the like.

The above silica source particles may contain impurities such as sodium oxide (Na₂O) and potassium oxide (K₂O), with the proviso that from a viewpoint of preventing a rise of thermal expansion ratio and enhancing the heat resistance, it is preferable that a ratio of the total mass of the impurities with respect to the total mass of the silica source particles is 0.01 mass % or less (i.e., 0 to 0.01 mass %). The kaolin particles may contain mica, quartz or the like as impurities, with the proviso that from the viewpoint of preventing the rise of the thermal expansion ratio and enhancing the heat resistance, it is preferable that the ratio of the total mass of the impurities with respect to the total mass of the kaolin particles is 2 mass % or less (i.e., 0 to 2 mass %).

There is not any special restriction on an average particle diameter of the silica source particles, but there are preferably used quartz particles having an average particle diameter of approximately 5 to 50 μm, kaolin particles having an average particle diameter of 2 to 10 μm, talc particles having an average particle diameter of 5 to 40 μm, or mullite particles having an average particle diameter of 2 to 20 μm.

The alumina source particles may be particles of alumina, alumina-containing composite oxide, a substance converted into alumina when fired or the like, with the proviso that it is preferable to use commercially available particles containing a small amount of impurities which are particles of alumina or aluminum hydroxide (Al(OH)₃), and it is further preferable to use particles of both of alumina and aluminum hydroxide. There is not any special restriction on the average particle diameter of the alumina source particles, but there are preferably used alumina particles having an average particle diameter of approximately 1 to 10 μm or aluminum hydroxide particles having an average particle diameter of 0.2 to 10 μm.

The magnesia source particles may be particles of magnesia, magnesia-containing composite oxide, a substance converted into magnesia when fired or the like. Typical examples of the particles include particles of talc, magnesite (MgCO₃) and the like, and above all, the talc particles are preferable.

These magnesia source particles may contain impurities such as iron oxide (Fe₂O₃), calcium oxide (Cao), sodium oxide (Na₂O) and potassium oxide (K₂O), with the proviso that from a viewpoint of preventing the rise of the thermal expansion ratio and enhancing the heat resistance, it is preferable that a mass ratio of iron oxide with respect to the total mass of the magnesia source particles is 0.1 to 2.5 mass %. It is similarly preferable that a ratio of the total mass of calcium oxide, sodium oxide and potassium oxide with respect to the total mass of the magnesia source particles is 0.35 mass % or less (i.e., 0 to 0.35 mass %).

There is not any special restriction on an average particle diameter of the magnesia source particles, but there are preferably used talc particles having an average particle diameter of approximately 5 to 40 μm (preferably 10 to 30 μm) or magnesite particles having an average particle diameter of 4 to 8 μm.

When the above is generally taken into consideration, it is preferable that the cordierite forming material particles are: the silica source particles including silica particles having an average particle diameter of 5 to 50 μm and kaolin particles having an average particle diameter of 2 to 10 μm; the alumina source particles including alumina particles having an average particle diameter of 1 to 10 μm and aluminum hydroxide particles having an average particle diameter of 0.2 to 10 μm; and the magnesia source particles including talc particles having an average particle diameter of 10 to 30 μm, these particles being mixed at ratios of 5 to 25 mass %. 0 to 40 mass %, 5 to 35 mass %, 0 to 25 mass % and 35 to 45 mass %, respectively.

As described above, as the raw material particles, various types of particles can be used, but in the producing method of the present invention, as at least one type of raw material particles, it is necessary to use particles containing particles (spherical particles) having a circularity of 0.70 to 1.00, it is preferable to use particles containing particles having a circularity of 0.80 to 1.00, and it is especially preferable to use particles containing particles having a circularity of 0.85 to 1.00. In this case, in a case where the raw material particles, the microcapsules and the like are mixed and kneaded, since there is effectively prevented a situation in which the microcapsules are damaged and collapsed by aspherical particles, it is possible to enjoy an effect that the inherent pore-forming effect of the pore-forming agent can be exerted to the maximum, and the high-porosity porous ceramic structure can be obtained by the addition of the small amount of the pore-forming agent. The spherical particles are also preferable in that they exist stably at a high temperature during firing, and a pore diameter is easily controlled.

It is to be noted that to obtain the effect of the present invention, it is preferable that the circularity of the aggregate particles is high, but the high circularity is sometimes disadvantageous in respect of productivity, production cost or the like. From such a viewpoint, it is preferable to use spherical particles having a circularity of 0.70 to 0.90, it is further preferable to use the spherical particles having a circularity of 0.80 to 0.90, and it is especially preferable to use the spherical particles having a circularity of 0.85 to 0.90. The spherical particles having such a circularity can comparatively easily be obtained by a method described later.

To securely obtain the above effect, a mass ratio of the spherical particles with respect to the total mass of at least one type of raw material particles needs to be 30 to 100 mass %, and it is preferable that the ratio is 40 to 100 mass %. The mass ratio of the spherical particles with respect to the total mass (i.e., the total mass of all components of the raw material particles) of the raw material particles may appropriately be set in accordance with conditions such as a type of raw material particles, and there is not any special restriction. The mass ratio is usually preferably 5 to 100 mass %, further preferably 10 to 100 mass %, especially preferably 20 to 100 mass %. However, as to the cordierite forming material particles, as described later, there also exist particles of talc, kaolin or the like. It is preferable that they are not spheroidized. The mass ratio is preferably 5 to 60 mass %, further preferably 10 to 55 mass %, especially preferably 20 to 50 mass %.

Examples of a method (spheroidizing treatment) for obtaining the above spherical particles include a method of heating ceramic particles at a temperature in a range of a melting point (Tm) of the ceramic to Tm+300° C. When the ceramic particles are heated at a temperature in a range of the melting point (Tm) of the ceramic to Tm+300° C., the surfaces of the ceramic particles melt, and it is possible to obtain spherical particles having less edge portions. Since, for example, a melting point of silica is 1730° C., the spheroidizing treatment can easily be performed by a method of heating the particles in flame at a temperature in a range of 1730 to 2030° C. That is, as the silica source particles, it is preferable to use the silica particles subjected to such a heating treatment.

Moreover, a method of crushing the ceramic particles with a jet air current can also preferably be used. When the ceramic particles are crushed with the jet air current, the surfaces of the ceramic particles are worn, and it is possible to obtain spherical particles having less edge portions. Typical examples of the method include a method in which the ceramic particles are jet under pressure from nozzles together with a high-pressure gas of air, nitrogen or the like by use of a device such as a jet mill, and the crushing treatment is performed by use of friction or collision of the ceramic particles themselves.

The above spheroidizing treatment may be performed with respect to all the raw material particles. For example, in a case where only one type of raw material particles such as silicon carbide is used, one of preferable modes is that all the raw material particles are spheroidized. In a case where as the raw material particles, the cordierite forming material particles are used which are composed of five types of particles of silica, kaolin, alumina, aluminum hydroxide and talc, it is preferable that at least one type of the silica particles, the alumina particles and aluminum hydroxide particles is spheroidized treatment. It is further preferable that all of the silica particles, the alumina particles and the aluminum hydroxide particles are spheroidized.

Among commercial silica, alumina and aluminum hydroxide particles, there are many particles having angular aspherical shapes, such as crushed silica or electromelted alumina described above. In a case where a clay material is mixed and kneaded, remarkably thin shell portions of the microcapsules might be damaged or crushed.

On the other hand, it is preferable that the talc particles and kaolin particles are not spheroidized. For example, in a case where a formed body having a honeycomb shape is obtained by use of extrusion forming to extrude the material from a die with slits having a shape complementary to that of the partition wall to be formed, plate-like crystals of talc or kaolin are oriented when passing through the die slits. Therefore, a preferable effect is produced that a finally obtained porous honeycomb structure is expanded with low heat.

(ii) Pore-Forming Agent:

The pore-forming agent is an additive which burns out during the firing of the formed body to form pores, whereby the porosity is increased and the high-porosity porous ceramic structure is obtained. The pore-forming agent needs to be a combustible substance which burns out during the firing of the formed body, and in the producing method of the present invention, hollow particles (microcapsules) made of an organic resin are used. Since the microcapsules are hollow particles, the pore-forming effect per unit mass is high, and it can be expected that the high-porosity ceramic structure is obtained with the addition of a small amount of the agent. Especially in the producing method of the present invention, since the spherical particles having the circularity appropriately controlled are used as the raw material particles, it is possible to exert the inherent pore-forming effect of the microcapsules to the maximum.

(iii) Dispersion Medium and Another Additive:

Examples of a dispersion medium for use in mixing and kneading the raw material particles and the pore-forming agent include water, and a mixed solvent of water with an organic solvent such as alcohol, and water is especially preferably used.

An organic binder is an additive which imparts fluidity to a clay when formed and which gels in a dried ceramic body before fired to perform a function of maintaining a mechanical strength of the dried article as a reinforcing agent. Therefore, as the binder, there can preferably be used, for example, hydroxypropyl methyl cellulose, methyl cellulose, carboxyl methyl cellulose, polyvinyl alcohol or the like.

A dispersant is an additive which promotes dispersion of the raw material particles and the like into the dispersion medium to obtain a homogeneous clay. Therefore, as the dispersant, there can preferably be used a substance having an interface activating effect, such as ethylene glycol, dextrin, fatty acid soap or polyalcohol.

(iv) Mixing and Kneading:

The above raw material particles, pore-forming agent, dispersion medium and the like are mixed and kneaded by a conventional known mixing and kneading method, with the proviso that it is preferable to perform the mixing by a method of stirring the materials while applying a shearing force thereto by use of a mixing machine capable of rotating a stirring blade at a high speed of 500 rpm or more (preferably 1000 rpm or more), the machine having an excellent stirring force and dispersing force. According to such a mixing method, it is possible to crush and eliminate an aggregate of fine particles included in the raw material particles, the aggregate being a cause for an inner defect of the porous ceramic structure.

There can preferably be used, for example, a plowshare mixer (e.g., trade name: Ploughshare Mixer manufactured by Pacific Machinery & Engineering Co., Ltd., trade name: WA manufactured by WAM Japan Kabushiki Kaisha, trade name: WA-75 manufactured by YAMATO Kihan Kabushiki Kaisha or the like) which is a mixer of such a type that a horizontal cylindrical drum includes therein a plow or shovel-like stirring blade (plowshare) and a stirring blade (chopper) having a cross knife shape. The plowshare rotates around a driving shaft disposed in a horizontal direction at a low speed, and the chopper rotates around a driving shaft disposed in a vertical direction at a high speed. According to the plowshare mixer, a floating diffusion function of the plowshare is combined with a high-speed sharing function of the chopper, and the aggregate of fine particles included in the raw material particles is crushed.

Moreover, there can preferably be used the Henschel mixer (e.g., trade name: Mitsui Henschel Mixer manufactured by Mitsui Mining Co., Ltd. or the like) which is a mixer of such a type that a vertical cylindrical drum includes therein a multistage blade constituted of an impeller-like lower-stage stirring blade and an annular upper-stage stirring blade, this multistage blade being configured to rotate around a driving shaft disposed in a vertical direction. According to the above Henschel mixer, a function of winding upwards a forming material by the lower-stage stirring blade is combined with a strong shearing function of the upper-stage stirring blade, and there is crushed the aggregate formed by aggregating the fine particles included in the forming material.

When the stirring blade is rotated at a higher speed during the mixing, an effect of crushing the aggregate is enhanced, but in the present situation, an upper limit of the rotation speed in the above device is about 10000 rpm. That is, in the present invention, the rotation speed of the stirring blade is preferably 500 to 10000 rpm, more preferably 1000 to 5000 rpm.

There is not any special restriction on a stirring time, but it is preferable that the time is set to 5 to 30 minutes in a case where the stirring blade is rotated at 500 rpm, and the time is set to 3 to 20 minutes in a case where the blade is rotated at 1000 rpm. The stirring time which is less than the above range is not preferable in that the aggregate is easily insufficiently crushed, and the inner defect of a formed ceramic body (finally the porous ceramic structure) might not be prevented from being generated. The time exceeding the above region is not preferable in that wear on the mixing machine easily proceeds, and a lifetime of the machine might be shortened.

When water as the dispersion medium is to be mixed with the raw material particles, the pore-forming agent and the like at one time, it is difficult to uniformly disperse the materials. Therefore, in the producing method of the present invention, it is preferable that the mixing is performed while spraying water to the raw material particles, the pore-forming agent and the like. In this case, it is possible to avoid a phenomenon in which a moisture content fluctuates in accordance with a portion of the clay or the honeycomb formed body, and it is therefore possible to obtain the porous ceramic structure in which there is little fluctuation of the porosity in accordance with the portion.

The kneading can be performed by a conventional known kneading machine such as a sigma kneader, the Banbury mixer or a screw type extrusion kneading machine. It is especially preferable to use a kneading machine (e.g., a vacuum clay kneading machine, a biaxial continuous kneading extrusion forming machine or the like) including a vacuum reduced-pressure device in that it is possible to obtain a clay having less defects and satisfactory formability.

In addition, in the producing method of the present invention, the mixing and kneading step is preferable in which the mixed material is mixed and kneaded under a reduced pressure of −40000 Pa to −93000 Pa together with the dispersion medium to thereby obtain the clay. The pressure which is above −40000 Pa is not preferable in that the clay is insufficiently deaerated, many defects are therefore generated in the clay, and the formability of the clay becomes defective. On the other hand, if the pressure is less than −93000 Pa, a degree of pressure reduction is excessively high. Therefore, if there are damaged microcapsules, the microcapsules are collapsed owing to the reduced pressure, and the pore-forming effect of the microcapsules might deteriorate.

In the producing method of the present invention, it is preferable that first the material is kneaded by the sigma kneader, and further kneaded by the screw type extrusion kneading machine including the vacuum reduced-pressure device to obtain a cylindrically extruded clay.

(2) Forming and Drying Step:

In the producing method of the present invention, a second step is a forming and drying step of forming the clay to obtain the formed ceramic body, and drying the formed ceramic body to thereby obtain the dried ceramic body.

There is not any special restriction on a forming method, and a conventional known forming method can be used such as extrusion forming, injection forming or press forming, with the proviso that in a case where the porous honeycomb structure useful as a dust collecting filter is produced, it is possible to preferably use a method of extruding the clay prepared as described above by use of the die having a desired cell shape, partition wall thickness and cell density.

In the present description, “honeycomb” means a shape in which a large number of cells 3 are defined and formed by remarkably thin partition walls 4 as in a porous honeycomb structure 1 shown in FIG. 2. There is not any special restriction on the whole shape, and examples of the shape include a cylindrical shape shown in FIG. 2, and examples of the shape include the cylindrical shape shown in FIG. 2, a square pole shape and a triangle pole shape. There is not any special restriction on a cell shape (cell shape in a section perpendicular to a cell forming direction), and examples of the shape include the quadrangular cell shown in FIG. 2, a hexagonal cell and a triangular shape.

There is not any special restriction on a driving method, there can be used a conventional known drying method such as hot-air drying, microwave drying, dielectric drying, reduced-pressure drying, vacuum drying or freezing drying, and above all, a drying method of the hot-air drying combined with the microwave drying or the dielectric drying is preferable in that the whole formed body can quickly and uniformly be dried.

(3) Firing Step:

In the producing method of the present invention, a third step is a firing step of firing the dried ceramic body to thereby obtain the porous ceramic structure.

The firing means an operation to sinter the raw material particles to densify them, whereby a predetermined strength is secured. Since firing conditions (temperature and time) differ with a type of the raw material particles constituting the honeycomb formed body, appropriate conditions may be selected in accordance with the type of the particles. In a case where, for example, the cordierite forming material is used as the raw material particles, it is preferable to fire the material at a temperature of 1410 to 1440° C. for 3 to 7 hours. The firing conditions (temperature and time) which are less than the above range are not preferable in that the raw material particles might be insufficiently sintered. The conditions exceeding the above range are not preferable in that generated cordierite might be molten.

It is to be noted that before the firing or in a process of temperature rise during the firing, an operation (calcining) is performed to burn and remove organic matters (binder, pore-forming agent, dispersant, etc.) in the dried ceramic body, which is preferable in that the removal of the organic matters can further be promoted. Since a burning temperature of the binder is about 200° C., and a burning temperature of the pore-forming agent is about 300° C., a calcining temperature may be set to about 200 to 1000° C. There is not any special restriction on the calcining time, but the time is usually about 10 to 100 hours.

B. Porous Ceramic Structure:

According to the producing method of the present invention, a porous ceramic structure is obtained by mixing and kneading a clay material including silica particles, kaolin particles, alumina particles, aluminum hydroxide particles and talc particles, and a pore-forming agent together with a dispersion medium, and drying and firing the resultant, the porous ceramic structure containing cordierite as a main constituting component and having a porosity of 60 to 72% and an average pore diameter of 15 to 32 μm, as the pore-forming agent, hollow particles (microcapsules) made of an organic resin being used, further as at least one type of the silica particles, the alumina particles and the aluminum hydroxide particles, particles being used which contain 30 to 100 mass % of particles (spherical particles) having a circularity of 0.70 to 1.00 with respect to the total mass of the particles. Such a high-porosity porous ceramic structure can preferably be used in a filter application including a diesel particulate filter, additionally in a refractory material or the like in which a high porosity is required in order to improve a heat insulating property.

It is to be noted that to control the porosity in a range of 60 to 72%, a mass ratio of the microcapsules with respect to raw material particles (cordierite forming material particles) may be controlled. Specifically, when 1 to 3 parts by mass of microcapsules are added to 100 parts by mass of raw material particles, the porosity can be controlled in a range of 60 to 72%.

On the other hand, to control an average pore diameter in a region of 15 to 32 μm, an average particle diameter and a mass ratio of each type of cordierite forming material particles may be controlled. Specifically, as described above, the average particle diameter of the silica particles is controlled into 5 to 50 μm, the average particle diameter of the kaolin particles is controlled into 2 to 10 μm, the average particle diameter of the alumina particles is controlled into 1 to 10 μm, the average particle diameter of the aluminum hydroxide particles is controlled into 0.2 to 10 μm, and the average particle diameter of the talc particles is controlled into 10 to 30 μm. Thereafter, these particles may be mixed at mass ratios of 5 to 25 mass %. 0 to 40 mass %, 5 to 35 mass %, 0 to 25 mass % and 35 to 45 mass %, respectively, to prepare the raw material particles.

As a dust collecting filter, a porous honeycomb structure can preferably be used which exhibits a honeycomb shape constituted by defining and forming a large number of cells by porous partition walls. Above all, the structure further preferably includes plug portions which alternately plug one opening and the other opening of a large number of cells.

There is not any special restriction on a method of forming the plug portions, but examples of the method include a method of: attaching an adhesive sheet onto one end face of the porous honeycomb structure; perforating an only portion of the adhesive sheet corresponding to each cell to be plugged by laser processing or the like utilizing image processing to obtain a mask; submerging the end face of the porous honeycomb structure to which the mask is attached in ceramic slurry; filling each cell to be plugged in the porous honeycomb structure with the ceramic slurry to form each plug portion; performing a step similar to the previous step on the other end face of the porous honeycomb structure; drying the plug portion; and firing the structure. This plug portion may be formed in a dried ceramic body having a honeycomb shape, and the firing of the dried ceramic body may be performed simultaneously with the firing of the plug portion.

The ceramic slurry can be prepared by mixing at least the raw material particles and a dispersion medium (e.g., water or the like). Furthermore, if necessary, an additive such as a binder or a dispersant may be added. There is not any special restriction on a type of the raw material particles, but the same type as that of the raw material particles used as the material of the formed ceramic body may preferably be used. As the binder, it is preferable to use a resin such as polyvinyl alcohol or methyl cellulose. As the dispersant, it is preferable to use a special carboxylic acid type polymer surfactant.

It is preferable to adjust a viscosity of the ceramic slurry into a range of 5 to 50 Pa·s, and it is more preferable to adjust the viscosity into a range of 10 to 30 Pa·s. If the viscosity of the ceramic slurry is excessively low, a kink defect tends to be easily generated. The ratio of the slurry can be adjusted by, for example, a ratio between the raw material particles and the dispersion medium (e.g., water or the like), an amount of the dispersant or the like.

### EXAMPLES

The present invention will be described hereinafter in more detail in accordance with examples in which a high-porosity porous honeycomb structure having a porosity of 60% was produced, and comparative examples, with the proviso that the present invention is not limited by these examples at all.

### Examples 1 to 6

### Comparative Examples 1 to 3

As raw material particles, there were prepared particles containing five types of particles of kaolin (average particle diameter of 10 μm), talc (average particle diameter of 30 μm), aluminum hydroxide (average particle diameter of 3 um), alumina (average particle diameter of 6 μm) and silica (having an average particle diameter and a circularity described in Table 1) at a ratio of 19:40:15:14:12 (i.e., it is seen that in Examples 1 to 6, 100 mass % of the silica particles as one type of raw material particles is occupied by spherical particles, whereas the raw material particles of Comparative Examples 1 to 3) do not contain any spherical particle).

Moreover, to 100 parts by mass of the raw material particles, as an organic binder, 8 parts by mass of hydroxypropyl methyl cellulose were added and mixed for 3 minutes. Next, to this mixture, 2 parts by mass of microcapsules (average particle diameter of 40 μm) made of an acrylic resin were added and mixed for 3 minutes. Furthermore, while spraying 35 parts by mass of water to this mixture, water was added and mixed for 3 minutes. This mixing was all performed by use of a plowshare mixer (trade name: Ploughshare Mixer manufactured by Pacific Machinery & Engineering Co., Ltd.).

Thereafter, the above mixture was kneaded by a sigma type kneader for 60 minutes to obtain a clay, and the clay was further kneaded and extruded under a reduced pressure of −88000 Pa by a vacuum clay kneading machine, thereby obtaining the cylindrically formed clay.

According to the above method of extruding the above cylindrical clay by use of a die having a cell shape, partition wall thickness and cell density described later, a formed ceramic body having a honeycomb shape was obtained in which a large number of cells were defined and formed by partition walls. This forming was performed by a ram type extrusion forming machine.

The above formed ceramic body was microwave-dried, and further hot-air dried to obtain a dried ceramic body. This dried ceramic body was cut into predetermined dimensions, an adhesive sheet was attached to one end face of the article, an only portion of the adhesive sheet corresponding to each cell to be plugged was perforated by laser processing utilizing image processing to obtain a mask. The end face of the dried ceramic body to which the mask was attached was submerged in ceramic slurry, and each cell to be plugged in the dried ceramic body was filled with the ceramic slurry to form each plug portion. After a step similar to the previous step was performed on the other end face of the dried ceramic body, the plug portion was fired together with the dried ceramic body. As the ceramic slurry, slurry of cordierite forming material particles was used, and firing conditions were set to 1420° C. and 6 hours.

The resultant porous ceramic structure entirely exhibited a honeycomb shape in which an end face (cell opened face) shape was a 144 mmφ circle having a length of 152 mm, a cell shape was a square cell of about 1.47 mm×1.47 mm, a partition wall thickness was 0.3 mm and a cell density was about 47 cells/cm² (300 cells/square inch).

TABLE 1

| | Producing method | | | | | Porous ceramic | |
|---|---|---|---|---|---|---|---|
| | Silica particles | | | | | structure | |
| | Average | | | | | | Average |
| | particle | | | | | | pore |
| | diameter | | | Kneading | | Porosity | diameter |
| | (μm) | Circularity | Preparing process | machine | Forming machine | (%) | (μm) |
| Example 1 | 25 | 0.90 | Heating | Sigma | Ram type extrusion | 69 | 23 |
| | | | | kneader | forming machine | | |
| Example 2 | 38 | 0.86 | Heating | Sigma | Ram type extrusion | 67 | 29 |
| | | | | kneader | forming machine | | |
| Example 3 | 5 | 0.89 | Heating | Sigma | Ram type extrusion | 69 | 15 |
| | | | | kneader | forming machine | | |
| Example 4 | 50 | 0.85 | Heating | Sigma | Ram type extrusion | 66 | 32 |
| | | | | kneader | forming machine | | |
| Example 5 | 32 | 0.82 | Crushing | Sigma | Ram type extrusion | 65 | 23 |
| | | | | kneader | forming machine | | |
| Example 6 | 32 | 0.72 | Crushing | Sigma | Ram type extrusion | 62 | 21 |
| | | | | kneader | forming machine | | |
| Comparative | 28 | 0.68 | Untreated | Sigma | Ram type extrusion | 59 | 24 |
| Example 1 | | | (crushed silica) | kneader | forming machine | | |
| Comparative | 55 | 0.65 | Untreated | Sigma | Ram type extrusion | 56 | 24 |
| Example 2 | | | (crushed silica) | kneader | forming machine | | |
| Comparative | 3 | 0.67 | Untreated | Sigma | Ram type extrusion | 58 | 11 |
| Example 3 | | | (crushed silica) | kneader | forming machine | | |

| | | | | | | |
|---|---|---|---|---|---|---|
| Example 7 | 25 | 0.90 | Heating | Biaxial continuous kneading | 65 | 21 |
| | | | | extrusion forming machine | | |

(Evaluation)

As shown in Table 1, it has been recognized that as to the porous ceramic structures of Examples 1 to 6 in which 100 mass % of silica particles as one type of raw material particles are occupied by spherical particles, regardless of the method of preparing the spherical particles or the type of the forming machine, all of the structures have a porosity of 60% or more, and an inherent pore-forming effect of the pore-forming agent is effectively exerted. On the other hand, as to the porous ceramic structures of Comparative Examples 1 to 3 in which as the raw material particles, the particles containing no spherical particles are used, all of the structures have a porosity less than 60%, and a pore-forming effect cannot be obtained in accordance with an added amount of the pore-forming agent. As apparent from results of Examples 1 to 6, when the circularity of the spherical particles is high, the high-porosity porous ceramic structure can be obtained. Specifically, the porous ceramic structures of Examples 1 to 5 using the particles having a circularity of 0.80 to 1.00 indicate satisfactory results, and especially satisfactory results are indicated by the porous ceramic structures of Examples 1 to 4 using particles having a circularity of 0.85 to 1.00.

### Example 7

A porous ceramic structure having the same honeycomb shape as that of each of Examples 1 to 6 was obtained by a method similar to the method of Examples 1 to 6, except that a mixture obtained by a plowshare mixer was kneaded and formed under a reduced pressure of −88000 Pa by a biaxial continuous kneading extrusion forming machine.

### Examples 8 to 12

As raw material particles, there were prepared particles containing five types of particles of kaolin (average particle diameter of 10 μm), talc (average particle diameter of 30 μm), aluminum hydroxide (average particle diameter of 3 um), alumina (average particle diameter of 6 μm) and silica (an average particle diameter of 25 μm, a circularity of 0.90) at a ratio of 19:40:15:14:12.

Moreover, to 100 parts by mass of the raw material particles, as an organic binder, 8 parts by mass of hydroxypropyl methyl cellulose were added and mixed for 3 minutes. Next, to this mixture, 2 parts by mass of microcapsules (average particle diameter of 40 μm) made of an acrylic resin were added and mixed for 3 minutes. Furthermore, while spraying 35 parts by mass of water to this mixture, water was added and mixed for 3 minutes. This mixing was all performed by use of a plowshare mixer (trade name: Ploughshare Mixer manufactured by Pacific Machinery & Engineering Co., Ltd.).

Thereafter, the above mixture was kneaded by a sigma type kneader for 60 minutes to obtain a clay, and the clay was further kneaded and extruded under a reduced pressure described in Table 2 by a vacuum clay kneading machine, thereby obtaining the cylindrically formed clay. Thereafter, a porous ceramic structure having the same honeycomb shape as that of each of Examples 1 to 6 was obtained by a method similar to that of each of Examples 1 to 6.

TABLE 2

| | Producing method | | | | | |
|---|---|---|---|---|---|---|
| | | | | Clay | Porous ceramic | |
| | Silica particles | | | kneading | structure | |
| | Average | | | machine | | Average |
| | particle | | | vacuum | | pore |
| | diameter | | Preparing | degree | Porosity | diameter |
| | (μm) | Circularity | process | (Pa) | (%) | (μm) |
| Example 8 | 25 | 0.90 | Heating | −93000 | 68 | 22 |
| Example 9 | 25 | 0.90 | Heating | −88000 | 69 | 23 |
| Example 10 | 25 | 0.90 | Heating | −64000 | 71 | 24 |
| Example 11 | 25 | 0.90 | Heating | −40000 | 72 | 24 |

| | | | | | |
|---|---|---|---|---|---|
| Example 12 | 25 | 0.90 | Heating | −30000 | Non-formable |

(Evaluation)

As shown in Table 2, it has been recognized that as to the porous ceramic structures of Examples 8 to 12 in which 100 mass % of silica particles as one type of raw material particles are occupied by spherical particles, all of the structures have a porosity of 60% or more, and an inherent pore-forming effect of the pore-forming agent is effectively exerted, with the proviso that in Example 12 in which a vacuum degree of a clay kneading machine deviates from a range of −40000 Pa to −90000 Pa, there are many defects in the clay, and the clay cannot be formed.

### Examples 13 to 15

### Comparative Example 4

As raw material particles, there were prepared particles containing six types of particles of kaolin (average particle diameter of 10 μm), talc (average particle diameter of 30 μm), aluminum hydroxide (average particle diameter of 3 um), alumina (average particle diameter of 6 μm), silica A (an average particle diameter of 25 μm, a circularity of 0.90) and silica B (average particle diameter of 28 μm, circularity of 0.78) at a ratio described in Table 3 (i.e., it is assumed that in Examples 13 to 15, 42 mass % or more of the silica particles as one type of raw material particles are occupied by spherical particles, whereas in Comparative Example 4, less than 30 mass % of the silica particles as one type of raw material particles only contain spherical particles). Porous ceramic structures having the same honeycomb shape as that of each of Examples 1 to 6 were obtained by a method similar to that of each of Examples 1 to 6 except that the above raw material particles were used.

TABLE 3

| | | | | | | | Porous ceramic | |
|---|---|---|---|---|---|---|---|---|
| | | | | | | | structure | |
| | Producing method | | | | | | Characteristics | |
| | Raw material particles | | | | | | | Average |
| | | | | | Aluminum | | | pore |
| | Kaolin | Talc | Silica A | Silica B | hydroxide | Alumina | Porosity | diameter |
| | (mass %) | (mass %) | (mass %) | (mass %) | (mass %) | (mass %) | (%) | (μm) |
| Example 13 | 19 | 40 | 5(42) | 7(58) | 15 | 14 | 60 | 21 |
| Example 14 | 19 | 40 | 12(100) | 0 | 15 | 14 | 69 | 23 |
| Example 15 | 0 | 43 | 23(100) | 0 | 0 | 34 | 72 | 26 |
| Comparative | 19 | 40 | 3(25) | 9(75) | 15 | 14 | 58 | 19 |
| Example 4 | | | | | | | | |

* In parentheses, mass % is indicated with respect to the total mass of the silica particles.

(Evaluation)

As shown in Table 3, it has been recognized that as to the porous ceramic structures of Examples 13 to 15 in which 30 to 100 mass % (more specifically 40 to 100 mass %) of the silica particles as one type of raw material particles are occupied by spherical particles, all of the structures have a porosity of 60% or more, and an inherent pore-forming effect of the pore-forming agent is effectively exerted. On the other hand, as to the porous ceramic structure of Comparative Example 4 in which less than 30 mass % of the silica particles as one type of raw material particles only contain the spherical particles, the porosity is less than 60%, and a pore-forming effect cannot be obtained in accordance with an added amount of the pore-forming agent. As apparent from results of Examples 13 to 15, when the ratio of the spherical particles in the silica particles as one type of raw material particles is high, the high-porosity porous ceramic structure can be obtained. That is, in Examples 13 to 15 in which the ratio of the spherical particles in the silica particles is 30 to 100 mass % (more specifically 40 to 100 mass %), especially satisfactory results are obtained.

### INDUSTRIAL APPLICABILITY

In various fields including chemistry, electric power, iron and steel and industrial waste disposal, a method for producing a porous ceramic structure of the present invention can preferably be used for a dust collecting filter for use in applications of an environmental measure such as prevention of pollution, recovery of a product from a high-temperature gas and the like, especially for a diesel particulate filter for use in a high-temperature corrosive-gas atmosphere to trap particulate matters discharged from a diesel engine such as a car diesel engine.

1. A method for producing a porous ceramic structure, comprising: a mixing and kneading step of mixing and kneading a clay material containing raw material particles and a pore-forming agent together with a dispersion medium to obtain a clay; a forming and drying step of forming the clay to obtain a formed ceramic body, and drying the formed ceramic body to obtain a dried ceramic body; and a firing step of firing the dried ceramic body to thereby obtain the porous ceramic structure,
wherein as the pore-forming agent, hollow particles (microcapsules) made of an organic resin are used, and as at least one type of the raw material particles, particles are used which contain 30 to 100 mass % of particles (spherical particles) having a circularity of 0.70 to 1.00 with respect to the total mass of the raw material particles.

2. The method for producing the porous ceramic structure according to claim 1, wherein the spherical particles have a circularity of 0.80 to 1.00.

3. The method for producing the porous ceramic structure according to claim 1, wherein the clay is formed into a honeycomb shape in which a large number of cells are defined and formed by partition walls.

4. The method for producing the porous ceramic structure according to claim 1, wherein the spherical particles are obtained by heating ceramic particles at a temperature in a range of a melting point (Tm) of a ceramic to Tm+300° C.

5. The method for producing the porous ceramic structure according to claim 1, wherein the spherical particles are obtained by crushing the ceramic particles with a jet air current.

6. The method for producing the porous ceramic structure according to claim 1, wherein as the raw material particles, there are used cordierite (2MgO.2Al₂O₃.5SiO₂) forming material particles composed of silica (SiO₂) particles, kaolin (Al₂O₃.2SiO₂.2H₂O) particles, alumina (Al₂O₃) particles, aluminum hydroxide (Al(OH)₃) particles and talc (3MgO.4SiO₂.H₂O) particles, and as at least one type of the silica (SiO₂) particles, the alumina (Al₂O₃) particles and the aluminum hydroxide (Al(OH)₃) particles, there are used particles which contain 30 to 100 mass % of the spherical particles with respect to the total mass of the particles.

7. The method for producing the porous ceramic structure according to claim 6, wherein the spherical particles are obtained by heating the silica (SiO₂) particles in flame at a temperature in a range of 1730 to 2030° C.

8. The method for producing the porous ceramic structure according to claim 6, wherein the spherical particles are the silica (SiO₂) particles having an average particle diameter of 5 to 50 μm.

9. The method for producing the porous ceramic structure according to claim 1, wherein the mixing and kneading step mixes and kneads the mixed material together with the dispersion medium at a reduced pressure of −40000 Pa to −93000 Pa to thereby obtain the clay.

10. A porous ceramic structure obtained by: forming a clay obtained by mixing and kneading, together with a dispersion medium, a clay material containing silica (SiO₂) particles, kaolin (Al₂O₃.2SiO₂.2H₂O) particles, alumina (Al₂O₃) particles, aluminum hydroxide (Al(OH)₃) particles, talc (3MgO.4SiO₂.H₂O) particles and a pore-forming agent; drying the clay; and firing the clay, the porous ceramic structure containing cordierite (2MgO.2Al₂O₃.5SiO₂) as a main constituting component and having a porosity of 60 to 72% and an average pore diameter of 15 to 32 μm,
wherein as the pore-forming agent, hollow particles (microcapsules) made of an organic resin are used, and as at least one type of the silica (SiO₂) particles, the alumina (Al₂O₃) particles and the aluminum hydroxide (Al(OH)₃) particles, particles are used which contain 30 to 100 mass % of particles (spherical particles) having a circularity of 0.70 to 1.00 with respect to the total mass of the particles.

11. The porous ceramic structure according to claim 10, having a honeycomb shape in which a large number of cells are defined and formed by porous partition walls.

12. The porous ceramic structure according to claim 11, further comprising:
plug portions which alternately plug one opening of the large number of cells and the other opening thereof.
